(19) United States
(12) Patent Application Publication
(10) Pub. No.: US 2008/0238823 A1
(43) Pub. Date: Oct. 2, 2008

(54) Plasma display device and driving method thereof

(76) Inventor: Hak-Ki Choi, Suwon-si (KR)

Correspondence Address: ROBERT E. BUSHNELL, 1522 K STREET NW, SUITE 300, WASHINGTON, DC, 20005-1202, US

(21) Appl. No.: 12/078,169

(22) Filed: Mar. 27, 2008

(30) Foreign Application Priority Data
Mar. 28, 2007 (KR) 10-2007-0030431

(51) Int. Cl. G09G 3/28; H04N 5/46

(52) U.S. Cl. 345/60; 348/555

(57) ABSTRACT

Disclosed plasma display device includes a plurality of electrodes, drivers, a plurality of discharge cells and a controller which detects the frequency of an input video signal, determines whether the frequency is changed compared to that of a previous input video signal, and determines whether or not applying a control waveform to the plasma display device.

Disclosed driving method concerns resetting discharge cells during a predetermined time period. In the driving method for the plasma display panel by a plurality of subfields divided from a frame, the frequency of a video signal input for a frame is detected, a frequency change is determined from the detected frequency, and a plurality of discharge cells are reset for a predetermined period before the frame starts transmitting when the frequency is changed.

### CLAIM OF PRIORITY

This application makes reference to, incorporates the same herein, and claims all benefits accruing under 35 U.S.C. §119 from an application earlier filed in the Korean Intellectual Property Office on 28 Mar. 2007 and there duly assigned Serial No. 10-2007-0030431.

### BACKGROUND OF THE INVENTION

1. Field of the Invention

The present invention relates to a plasma display device and a driving method thereof, more particularly, to a plasma display device for stably driving subsequent frames when the 11 frequency of an input video signal changes, and a driving method thereof.

2. Description of the Related Art

A plasma display device is a flat panel display for displaying characters or images by using plasma generated by a gas discharge.

In general, a plasma display device is driven by dividing a plurality of subfields with weights from a frame. The plasma display device uses the NTSC (National Television System Committee) method based on a frequency of 60 Hz and the PAL (Phase Alternation Line) method based on a frequency of 50 Hz. In other words, time for one frame in the NTSC method is given as 16.67 ms (i.e., 1/60 Hz), and time for one frame in the PAL method is given as 20 ms (i.e., 1/50 Hz).

The controller of the plasma display device determines whether the frequency of video signals of one frame is 60 Hz or 50 Hz, and realizes images by using one of NTSC and PAL methods corresponding to the determined frequency. When the frequency of the presently input video signals is different from that of the video signals input in the previous frame, the controller outputs a control signal for providing a transition period between the frames so that the current frame may be driven by a method different from the method used to drive the previous frame. Since wall charges and space charges formed in the previous frame are quenched during the transition period, however, the subsequent frame may not be normally driven.

The above information disclosed in this Background section is only for enhancement of understanding of the background of the invention and therefore it may contain information that does not form the prior art that is already known in this country to a person of ordinary skill in the art.

### SUMMARY OF THE INVENTION

It is, therefore, one object of the present invention to provide an improved plasma display device to eliminate the problems of the contemporary design of the plasma display device as stated above.

It is another object of the present invention to provide a plasma display device for stably driving subsequent frames when the frequency of an input video signal changes, and a driving method thereof.

An exemplary embodiment of the present invention provides a plasma display device driving method by dividing a frame into a plurality of subfields, and the plasma display device having a plurality of discharge cells. When the frequency of an video signal input during the frame is detected and a frequency change between one frame and the previous frame is determined from the detected frequency, the discharge cells are reset during a predetermined period before the consequent frame starts. The discharge cells include a plurality of first electrodes and a plurality of second electrodes, and the respective discharge cells are defined by the first electrodes and the second electrodes. The procedure of resetting of the discharge cells includes steps of gradually increasing the voltage of the second electrodes from a second voltage to a third voltage while a first voltage is applied to the first electrodes, and gradually decreasing the voltage of the second electrodes from a fifth voltage to a sixth voltage while a fourth voltage that is greater than the first voltage is applied to the first electrodes. During the discharge cells resetting, the voltage increasing and the decreasing at second electrode are repeated by a predetermined number of times. The frequency of the input video signal is one of a vertical synchronous frequency of the national television standard committee (NTSC) method and a vertical synchronous frequency of the phase alternating by line (PAL) method. The single frame is divided into a plurality of subfields each having a weight, and the respective subfields have an address period and a sustain period. In the method, a cell to be turned on is selected from among the discharge cells in the address period, and the cell to be turned on is sustain discharged in the sustain period. When the frequency of the input video signal is the vertical synchronous frequency of the PAL method, a plurality of subfields forming the frame are allocated to two groups according to the order of weights.

Another embodiment of the present invention provides a plasma display device including a controller and a driver. The controller divides a frame into a plurality of subfields and determines a frequency change from the frequency detected from the video signal that is input during the frame, the driver applies a waveform in which the voltage of the electrodes is gradually increased for a predetermined period before the frame starts, and the voltage of the electrodes is gradually decreased at least once when the frequency is changed. The plasma display device further includes a plurality of other electrodes. The other electrodes perform a display operation together with the first and second electrodes. The driver applies a voltage that is greater than the voltage applied to the other electrodes while the voltage of the electrodes is gradually decreased in the predetermined period and while the voltage of the other electrodes is gradually increased. The predetermined period is a period in which the PAL method is changed to the NTSC method or it is a period in which the NTSC method is changed to the PAL method according to the detected frequency. The controller divides the frame into a plurality of subfields each having a weight and drives those plurality of subfields, and the driver sequentially applies a scan pulse to the electrodes during an address period and alternately applies a sustain pulse to the electrodes and the other electrodes during a sustain period in the respective subfields. In the case of driving the frame according to the PAL method corresponding to the detected frequency, a plurality of subfields forming one frame are allocated to two groups in the order of weights and are then arranged.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicated the same or similar components, wherein:

FIG. 1 is a brief diagram of a plasma display device constructed as an exemplary embodiment of the present invention.

FIG. 2 shows a subfield arrangement of plasma display device constructed as a first exemplary embodiment of the present invention.

FIG. 3A and FIG. 3B respectively show subfield arrangements of the N-th frame and the (N+1)-th frame constructed as another exemplary embodiment of the present invention.

FIG. 4 shows a group of driving waveforms driven by a plasma display device constructed as another exemplary embodiment of the present invention.

FIG. 5 shows an entire-cell wall charge control waveform for a plasma display device constructed as another exemplary embodiment of the present invention.

FIG. 6 shows an flow chart of an operation of a controller in a plasma display device constructed as another exemplary embodiment of the present invention.

### DETAILED DESCRIPTION OF THE INVENTION

In the following detailed description, only certain exemplary embodiments of the present invention are shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification. A connection of a first unit to a second unit includes a physical connection thereof and an electrical connection of the first unit to the second unit with a third component therebetween. A frame in this application has the same meaning as a field.

Throughout this specification and the claims that follow, when an element is described to be “coupled” to another element, this element may be “directly physically coupled” to the other element or “electrically coupled” to the other element through a third element. In addition, unless explicitly described to the contrary, the word “comprise” and variations such as “comprises” or “comprising” should be understood to include stated elements without excluding any other elements.

A plasma display device and a driving method thereof according to an exemplary embodiment of the present invention will be described in details.

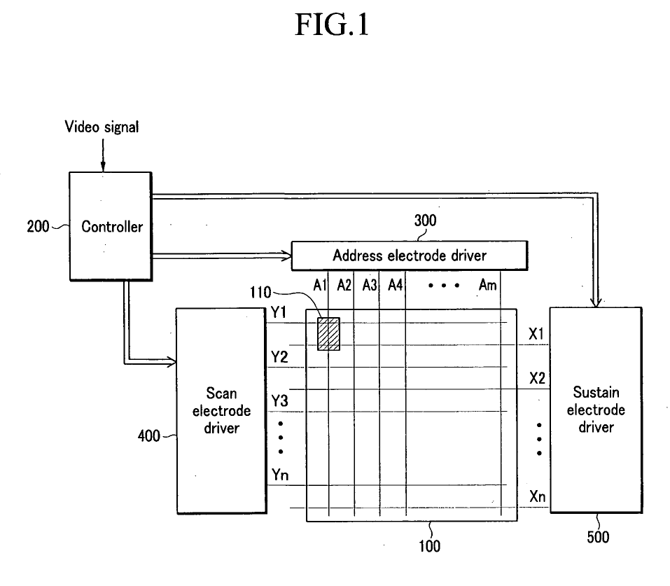

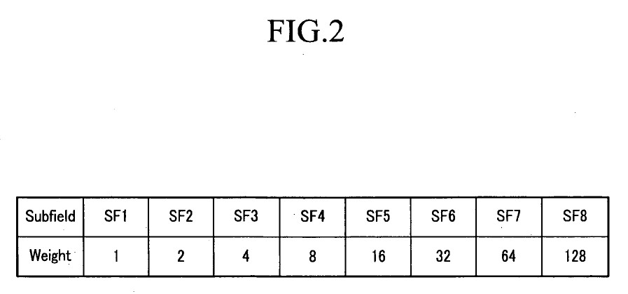

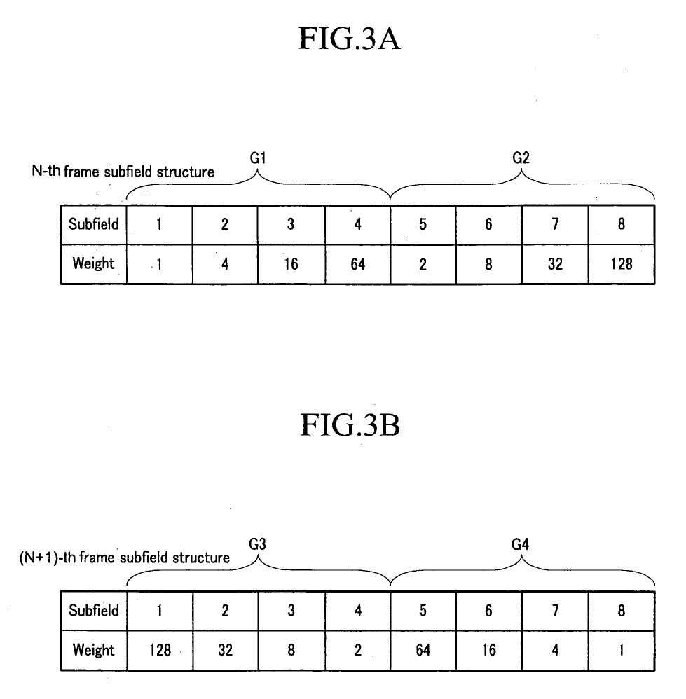

FIG. 1 is a brief diagram of a plasma display device constructed according to an exemplary embodiment of the present invention. FIG. 2 shows a subfield arrangement of plasma display device constructed according to a first exemplary embodiment of the present invention, and FIG. 3A and FIG. 3B respectively show subfield arrangements of the N-th frame and the (N+1)-th frame constructed according to another exemplary embodiment of the present invention.

As shown in FIG. 1, the plasma display device includes a plasma display panel (PDP) 100, a controller 200, an address electrode driver 300, a scan electrode driver 400, and a sustain electrode driver 500.

Plasma display panel (PDP) 100 includes a plurality of address electrodes A1-Am arranged in the vertical direction, and a plurality of sustain electrodes X1-Xn and a plurality of scan electrodes Y1-Yn arranged in pairs in the horizontal direction. Sustain electrodes X1-Xn are formed corresponding to scan electrodes Y1-Yn. In this instance, discharge spaces provided at the crossing regions of address electrodes A1-Am and sustain and scan electrodes X1-Xn and Y1-Yn form discharge cells 110. Hereinafter discharge cells 110 are referred to as cells 110. Plasma display panel (PDP) 100 mentioned above is only one example of panels, and other types of panels to which the driving waveform to be subsequently described is applicable can also be applied to the present invention.

Controller 200 receives an external video signal and outputs an address electrode drive control signal, a sustain electrode drive control signal, and a scan electrode driving signal. As shown in FIG. 2, controller 200 divides one frame into a plurality of subfields SF1-SF8, each subfield has an corresponding weight, and controller 200 represents grayscales by the combination of weights of subfields SF1-SF8. In FIG. 2, one frame has eight subfields withweights of 1, 2, 4, 8, 16, 32, 64 and 128 respectively, thereby displaying the grayscales in an intensity from 0 to 256. In this instance, when the subfield arrangement as shown in FIG. 2 is applied to the PAL method having a longer frame time than that of the NTSC method, the subfields having the greater weights are all arranged in the last part of one frame so that a user may sense a screen flicker phenomenon.

To reduce the flick phenomenon, another method of subfields arrangement is provided as shown in FIG. 3A and FIG. 3B. In the PAL method, a plurality of subfields are divided into two groups, and the subfields are alternately provided to the respective groups in the order of weights. Accordingly, the subfields with greater weights are separated into two different groups and the user perceives that the screens are changed at regular intervals of ten milliseconds (10 ms). The flicker phenomenon can be reduced because users can barely visually sense an interval of 10 ms accurately by with unaided eyes. When one frame (e.g., the N-th frame) has the subfield arrangement as shown in FIG. 3A, the frame (e.g., the (N+1)-th frame) following the N-th frame may have the same subfield arrangement as shown in FIG. 3A or the subfield arrangement as shown in FIG. 3B different from FIG. 3A. The first group may include the subfields with weights of 1, 4, 16 and 64 and the second group may include subfields with weights of 2, 8, 32 and 128 within one frame (e.g., the N-th frame) as shown in FIG. 3A; the first group may include subfields with weights of 128, 32, 8 and 2 and the second group may include subfields with weights of 64, 16, 4 and 1 within another frame (e.g., the (N+1)-th frame). The weights for the respective groups according to the exemplary embodiment of the present invention can be realized with many different values and are not restricted to the current exemplary embodiment. In this particular embodiment, controller 200 detects the frequency of the input video signal during one frame, and when the detected frequency of the input video signal is different from the frequency of the input video signal during the previous frame, controller 200 outputs a control signal for controlling the entire-cell wall charge control waveform is to be applied to the respective electrodes Y, X, and A during a transition period between the frames. Here, scan electrode Y is one of scan electrodes Y1-Yn, sustain electrode X is one of sustain electrodes X1-Xn, and address electrode A is one of address electrodes A1-Am. The entire-cell wall charge control waveform controls the wall charges so that the state of the wall charges formed at the respective electrodes may become uniform when the frequency of the input video signals is changed (e.g., either from 50 Hz to 60 Hz or from 60 Hz to 50 Hz). The term “wall charge” refers to charges formed close to an electrode on a wall (for example, a dielectric layer) of a discharge cell. Although wall charges do not actually come in contact with an electrode, the wall charges will be described as being “formed” or “accumulated” on the electrode. The term “wall voltage” refers to a potential formed on the wall of a discharge cell by wall charges. The term “space charge” refers to charges which exist in a space within a discharge cell.

Address electrode driver 300 receives the address electrode drive control signal from controller 200, and selectively applies an address pulse to a plurality of address electrodes A1-Am to determine the cell that will be turned on during an address period.

Scan electrode driver 400 receives a scan electrode drive control signal from controller 200 and applies a driving voltage to scan electrodes Y1-Yn.

Sustain electrode driver 500 receives a sustain electrode drive control signal from IX controller 200 and applies a driving voltage to sustain electrodes X1-Xn.

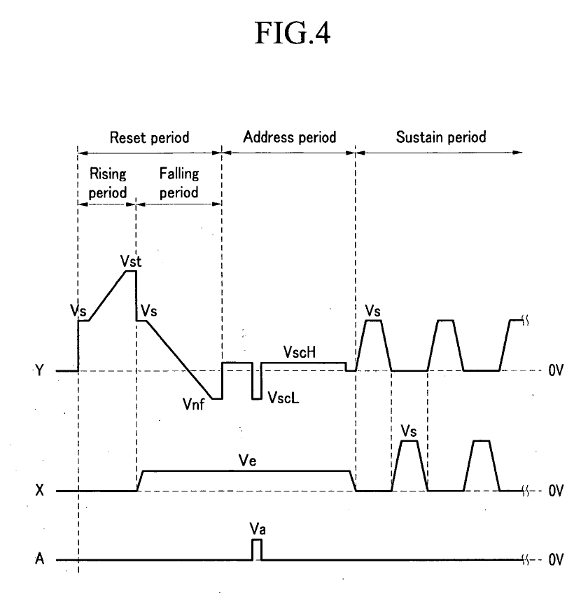

Driving waveforms for the respective electrodes X, Y, and A during the respective subfields will now be described with reference to FIG. 4.

FIG. 4 shows a plasma display device driving waveform according to an exemplary embodiment of the present invention. For better understanding and ease of description, FIG. 4 shows the driving waveforms of one subfield among a plurality of subfields forming one frame, and shows respectively the driving waveforms applied to sustain electrode X, scan electrode Y, and address electrode A forming one cell.

As shown in FIG. 4, in the rising period of the reset period, the voltages at sustain electrode X and address electrode A are maintained at the reference value of 0V, and the voltage at scan electrode Y is gradually increased from Vs to Vset. While the voltage at scan electrode Y is increased, a weak discharge generates between scan electrode Y and sustain electrode X and between scan electrode Y and address electrode A, and hence negative wall charges are formed at scan electrode Y and positive wall charges are formed at sustain electrode X and address electrode A.

At the end of the rising period, the voltage at scan electrode Y has a sudden drop from Vst to Vs.

In the falling period of the reset period, the voltage at scan electrode Y stays at voltage Vs for a predetermined time period and then is gradually decreased from Vs to Vnf, while the voltages of address electrode A and sustain electrode X are respectively maintained at the reference voltage of 0V and at Ve in the falling period of the reset period. While the voltage at scan electrode Y is decreased in the falling period of the reset period, a weak discharge is generated between scan electrode Y and sustain electrode X and between scan electrode Y and address electrode A, and hence the negative charges formed at scan electrode Y and the positive wall charges formed at sustain electrode X and address electrode A are eliminated. In general, when the voltage of (Vnf-Ve) is set to be near the discharge firing voltage between scan electrode Y and sustain electrode X, the wall voltage between scan electrode Y and sustain electrode X almost reaches 0V. As a result, the cell that is not address discharged in an address period is prevented from being misfired in a sustain period.

In the address period, the cell that is to be turned on is selected. While voltage Ve is applied to sustain electrode X, a scan pulse VscL is applied to scan electrode Y and an address pulse having a positive voltage Va is applied to address electrode A of the selected cell. In this instance, 0V is applied to other address electrodes of the cells that will not be turned on. An address discharge is generated between a selected address electrode A to which voltage Va is applied and sustain electrode Y to which voltage VscL is applied.

Referring to FIG. 1 and FIG. 4, in the address period, scan electrode driver 400 and address electrode driver 300 apply a scan pulse VscL to scan electrode Y1, and simultaneously apply an address pulse to address electrode A provided at the light emitting cell of the first row. In this instance, the voltage of VscH is applied to scan electrodes Y2-Yn. An address discharge is generated between scan electrode Y1 and address electrode A to which the address pulse is applied, and hence the positive wall charges are formed at scan electrode Y, and the negative wall charges are formed at address electrode A and sustain electrode X. Scan electrode driver 400 and address electrode driver 300 apply a scan pulse to scan electrode Y2 and apply an address pulse to address electrode A provided at the light emitting cell of the second row. In a like manner, the voltage of VscH is applied to the scan electrodes Y1 and Y3-Yn. The cell formed by address electrode A to which the address pulse is applied and scan electrode Y2 is address discharged to form wall charges at the cell. In a like manner, scan electrode driver 400 and address electrode driver 300 form wall charges by applying an address pulse to the address electrode A provided at the light emitting cell while sequentially applying scan pulses to the scan electrodes of other rows.

In the sustain period, a sustain pulse having a high voltage of Vs and a low voltage of 0V in sequence is applied to scan electrode Y and sustain electrode X in opposite phases respectively as shown in FIG. 4. In other words, 0V is applied to sustain electrode X when the voltage of Vs is applied to scan electrode Y, and the voltage of Vs is applied to sustain electrode X when 0V is applied to scan electrode Y. Accordingly, the voltage difference between scan electrode Y and sustain electrode X equals the voltage of Vs and the voltage of −Vs in a sequence, and a sustain discharge is repeated in a predetermined time period at the discharge cell turned on.

A plurality of subfields are realized by repeating the process for applying the sustain pulse to scan electrode Y and to sustain electrode X during the sustain period by the number of the weight displayed by the corresponding subfield.

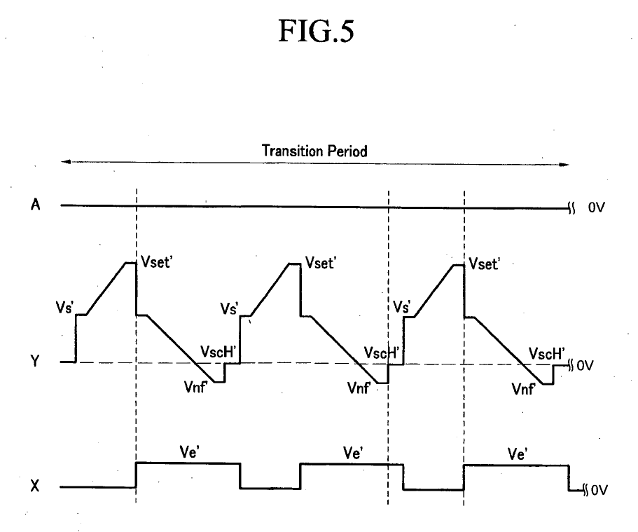

An entire-cell wall charge control waveform of a plasma display device according to an exemplary embodiment of the present invention will now be described referring to FIG. 5. FIG. 5 shows an entire-cell wall charge control waveform for a plasma display device constructed as an exemplary embodiment of the present invention. The entire-cell wall charge control waveform is applied to respective electrodes Y, X, and A in the transition period provided between the frames.

In the transition period as shown in FIG. 5, a waveform similar to the reset waveform shown in FIG. 4 that is applied to scan electrode Y, sustain electrode X, and address electrode A is applied at least once to scan electrode Y, sustain electrode X, and address electrode A. FIG. 5 illustrates that a waveform similar to the reset waveform is repeatedly applied three times in the wall charge control period. The wall charge control period refers to the transition period. That is, while the voltages at address electrode A and sustain electrode X are maintained at 0V, the voltage at scan electrode Y is gradually increased from the voltage of Vs′ to the voltage of Vset′. While the voltage at scan electrode Y is increased, a weak discharge is generated between scan electrode Y and sustain electrode X and between scan electrode Y and address electrode A, negative wall charges are formed at scan electrode Y, and positive wall charges are formed at sustain electrode X and address electrode A. While the voltage at sustain electrode X is maintained at the voltage of Ve′, the voltage at scan electrode Y is gradually decreased from the voltage of Vs′ to the voltage of Vnf′. While the voltage at the scan electrode Y is decreased, a weak discharge is generated between scan electrode Y and sustain electrode X and between scan electrode Y and address electrode A, and the negative wall charges formed at scan electrode Y and the positive wall charges formed at sustain electrode X and address electrode A are eliminated. The states of the wall charges of all cells become uniform when the waveform is repeatedly applied. Therefore, since no wall charges are lost and the priming particles are increased during the transition period, the subsequent frame is normally driven. In this instance, the voltages of Vs′, Vset′, Vnf′, and VscH′ may correspond to the voltages of Vs, Vset, Vnf and VscH.

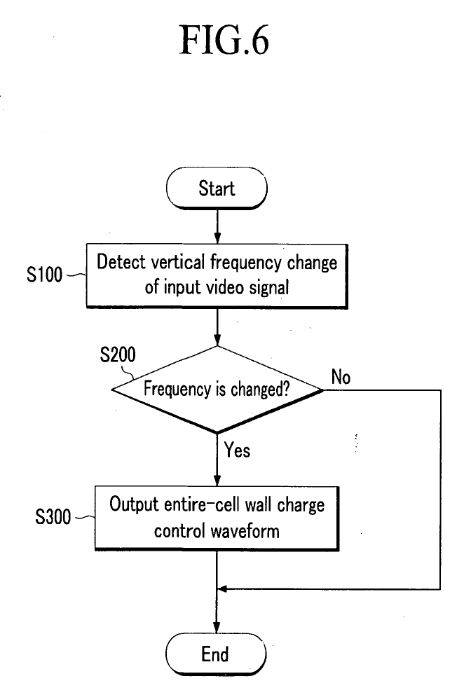

Controller 200 for determining whether or not to apply an entire-cell wall charge control waveform as shown in FIG. 5 to the plasma display device is now be shown in FIG. 6.

FIG. 6 shows an operation procedure of controller 200 in a plasma display device according to an exemplary embodiment of the present invention.

As shown in FIG. 6, in a step S100, controller 200 detects the frequency of the video signal input during one frame (e.g., the N-th frame). In a step 200, controller 200 determines whether or not the frequency detected in step S100 is different from the frequency of the video signal of the previous frame (e.g., the (N−1)-th frame) and thus check the variation video signal frequency.

In a step S300, when the frequency is changed according to the result of step S200, controller 200 outputs a control signal for applying an entire-cell wall charge control waveform as shown in FIG. 5 to respective electrodes X, Y, and A during the transition period that is provided before the frame (the N-th frame) starts and after the previous frame (the (N−1)-th frame) terminates. If the frequency of the video signal is changed, the waveform as shown in FIG. 5 is applied to the plasma display device, and if the frequency of the video signal is not changed, the waveform as shown in FIG. 4 is applied to the plasma display device. More specifically, when the frequency of video signals is changed, the waveform as shown in FIG. 5 is applied to the plasma display device during the transition period and the driving waveform as shown in FIG. 4 is applied thereto afterwards. When there is no frequency change according to the determination result of step S200, controller 200 outputs a control signal for driving the frame (the N-th frame) without having a transition period.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

As described above, consecutive frames are stably driven when the frequency of the video signal is changed by using the entire-cell wall charge control waveform according to the exemplary embodiment of the present invention.

What is claimed is:

1. A plasma display device driving method, comprising:
dividing a plurality of subfields from a frame visually displayed by a plasma display device including a plurality of discharge cells, the plasma display device driving method, comprising:
detecting a frequency of an input video signal during inputting a frame into the plasma display device; and
when the frequency is changed, resetting the discharge cells during a predetermined period before the frame starts transmitting.

2. The plasma display device driving method of claim 1, wherein
the plasma display device further includes a plurality of first electrodes and a plurality of second electrodes, and the respective discharge cells are defined by the first electrodes and the second electrodes, and
the method of resetting of the discharge cells comprising:
gradually increasing the voltage of the second electrodes from a second voltage to a third voltage while a first voltage is applied to the first electrodes; and
gradually decreasing the voltage of the second electrodes from a fifth voltage to a sixth voltage while a fourth voltage that is greater than the first voltage is applied to the first electrodes.

3. The plasma display device driving method of claim 2, wherein
the resetting of the discharge cells further comprises repeating the increasing and the decreasing a predetermined number of times.

4. The plasma display device driving method of claim 1, wherein
the frequency of the input video signal is one of a vertical synchronous frequency of a national television standard committee (NTSC) method and a vertical synchronous frequency of a phase alternating by line (PAL) method.

5. The plasma display device driving method of claim 2, wherein
the frequency of the input video signal is one of a vertical synchronous frequency of a national television standard committee (NTSC) method and a vertical synchronous frequency of a phase alternating by line (PAL) method.

6. The plasma display device driving method of claim 3, wherein
the frequency of the input video signal is one of a vertical synchronous frequency of a national television standard committee (NTSC) method and a vertical synchronous frequency of a phase alternating by line (PAL) method.

7. The plasma display device driving method of claim 4, wherein
the single frame is divided into a plurality of subfields each having a weight, wherein the respective subfields have an address period and a sustain period, and
the method further comprising:
selecting a cell to be turned on from among the discharge cells in the address period; and
sustain discharging the cell to be turned on in the sustain period.

8. The plasma display device driving method of claim 5, wherein
the single frame is divided into a plurality of subfields each having a weight, wherein the respective subfields have an address period and a sustain period, and
the method further comprising:
selecting a cell to be turned on from among the discharge cells in the address period; and
sustain discharging the cell to be turned on in the sustain period.

9. The plasma display device driving method of claim 6, wherein
the single frame is divided into a plurality of subfields each having a weight, wherein the respective subfields have an address period and a sustain period, and
the method further comprising:
selecting a cell to be turned on from among the discharge cells in the address period; and
sustain discharging the cell to be turned on in the sustain period.

10. The plasma display device driving method of claim 7, wherein
when the frequency of the input video signal is the vertical synchronous frequency of the PAL method, a plurality of subfields forming the frame are allocated to two groups according to weights of individual subfield.

11. The plasma display device driving method of claim 8, wherein
when the frequency of the input video signal is the vertical synchronous frequency of the PAL method, a plurality of subfields forming the frame are allocated to two groups according to weights of individual subfield.

12. The plasma display device driving method of claim 9, wherein
when the frequency of the input video signal is the vertical synchronous frequency of the PAL method, a plurality of subfields forming the frame are allocated to two groups according to weights of individual subfield.

13. A plasma display device, comprising:
a plurality of electrodes;
a controller for dividing a frame into a plurality of subfields, and determining a frequency change by a frequency detected from an input video signal during inputting the frame; and
a driver for applying a waveform, in which a voltage of the electrodes is gradually increased and the voltage at the first electrodes is gradually decreased, at least one time for a predetermined time period before the frame starts transmitting, when the frequency is changed.

14. The plasma display device of claim 13, further comprising:
a plurality of second electrodes for performing a display operation together with the first electrodes, wherein
the driver applies a voltage, which is lower than the voltage applied to the second electrodes while the voltage at the first electrodes is gradually decreased, to the second electrodes while the voltage of the first electrodes is gradually increased.

15. The plasma display device of claim 13, wherein
the predetermined time period is a time period in which either a phase alternating by line (PAL) method is changed to a national television standard committee (NTSC) method or the NTSC method is changed to the PAL method according to the detected frequency.

16. The plasma display device of claim 13, comprised of:
the controller dividing the frame into a plurality of subfields each having a weight, and drives each of the plurality of subfields, and
the driver sequentially applying a scan pulse to the second electrodes during an address period and alternately applying a sustain pulse to the first electrodes and the second electrodes during a sustain period in the respective subfields.

17. The plasma display device of claim 16, wherein
when driving the frame is according to the PAL method corresponding to the detected frequency, a plurality of subfields forming one frame are allocated to two groups based on an order of weight of individual subfield and said subfields are arranged in said groups.

18. The plasma display device of claim 13, wherein the controller determines the frequency change between said frame and a previous input frame by detecting a frequency of said video signal during inputting said frame.

19. A driving method of plasma display device, comprising:
dividing a first frame of a first video signal into a plurality of subfields;
detecting a first frequency of the first video signal during inputting said first frame into said plasma display device, said plasma display device having a plurality of discharge cells; and
resetting the discharge cells a predetermined number of times during a predetermined time period before the frame starts transmitting, when the detected first frequency of said video signal is different from a second frequency of a second input video signal, and said second input video signal is input to the display device immediately before said first frame of the first video signal.

20. The plasma display device driving method of claim 19, with said discharge cells being arranged by a plurality of first electrodes, a plurality of second electrodes and a plurality of third electrode.

21. The plasma display device driving method of claim 19, in which said resetting the discharge cells comprising:
gradually increasing a voltage at the second electrodes from a second voltage to a third voltage while a first voltage is applied to the first electrodes; and
gradually decreasing the voltage of the second electrodes from a fifth voltage to a sixth voltage while a fourth voltage that is greater than the first voltage is applied to the first electrodes.

22. The plasma display device driving method of claim 19, further comprising:
sequentially applying a scan pulse to the second electrodes and applying a pulse to the third electrodes during an address period; and
alternately applying a sustain pulse to the first electrodes and the second electrodes with predetermined time intervals during a sustain period in the respective subfields.
